(19) United States
(12) Patent Application Publication
(10) Pub. No.: US 2019/0169716 A1
(43) Pub. Date: Jun. 6, 2019

(54) HIGH TEMPERATURE CAST ALUMINUM ALLOY FOR CYLINDER HEADS

(71) Applicant: GM GLOBAL TECHNOLOGY OPERATIONS LLC, DETROIT, MI (US)

(72) Inventors: Qigui Wang, Rochester Hills, MI (US); Michael J. Walker, Shelby Twp., MI (US); Andrew C. Bobel, Clinton Twp., MI (US)

(21) Appl. No.: 15/828,827

(22) Filed: Dec. 1, 2017

(51) Int. Cl. C22C 21/04; C22F 1/043; B22D 11/00; B22D 15/00; F02F 1/24

(52) U.S. Cl. CPC C22C 21/04; C22F 1/043; F02F 1/24; B22D 15/00; B22D 11/003

(57) ABSTRACT

Aluminum alloys having improved high temperature mechanical properties are provided. An aluminum alloy suitable for sand casting, permanent mold casting, or semi-permanent mold casting includes about 3 to about 12 weight percent silicon; about 0.5 to about 2.0 weight percent copper; about 0.2 to about 0.6 weight percent magnesium; about 0 to about 0.5 weight percent chromium; about 0 to about 0.3 weight percent each of zirconium, vanadium, cobalt, and barium; about 0 to about 0.3 weight percent each of strontium, sodium, and titanium; about 0 to about 0.5 weight percent each of iron manganese, and zinc; and about 0.0.1 weight percent of other trace elements. Also disclosed is a semi permanent mold cast article, such as an engine cylinder head.

### GOVERNMENT LICENSE RIGHTS

This invention was made with government support under DE-EE0006082 awarded by the US Department of Energy. The government has certain rights in the invention.

### FIELD

The present disclosure relates generally to aluminum alloys, and more particularly, to high temperature cast aluminum alloys that have improved casting quality and mechanical properties, as well as cast articles made therefrom, such as cylinder heads made from sand casting or semi-permanent mold casting.

### INTRODUCTION

Increasing demand for light-weighting and fuel efficiency in combustion engines has significantly increased engine power density, exhaust temperatures, and peak cylinder pressures. This poses a significant challenge on existing cast aluminum alloys for high temperature performance like cylinder heads. Cast aluminum alloys have been increasingly used in the automotive industry to replace cast iron in applications such as engine blocks and cylinder heads to reduce mass.

With increasing demand for fuel economy, high temperature properties including tensile, creep, and fatigue strength of the cast aluminum alloys become critical. Over the past 10 years the maximum operating temperature of components like cylinder heads has increased from approximately 170 C to temperatures exceeding 200 C. The increased operating temperatures have resulted in more severe high cycle fatigue (HCF) and more low cycle fatigue (LCF) and/or thermo-mechanical fatigue (TMF) damage in areas of cylinder heads exposed to high thermal gradients, where the complex out-of-phase transient thermo-mechanical fatigue loading is produced.

In today's cylinder head designs, the most commonly used cast aluminum alloys are A356, 319 and AS7GU (A356+0.5% Cu). The A356 alloy is a primary aluminum alloy with good ductility and fatigue properties at low to intermediate temperatures. However, above approximately 200 C, creep resistance and tensile strength of this alloy are rapidly degraded due to the rapid coarsening of Mg/Si precipitates in the alloy. The 319 alloy is a secondary aluminum alloy representing a lower cost alternative to the A356. The copper-bearing 319 alloy has the advantage of better tensile and creep strength at intermediate temperatures because the Al/Cu precipitates are stable to a higher temperature than the Mg/Si precipitates in A356. However, this alloy is prone to shrinkage porosity due to the high Fe and Cu content and low ductility at room temperature. The AS7GU alloy is a variant of A356, solid solution strengthened with 0.5% Cu. Like A356, the AS7GU alloy has good castability while the small copper addition improves creep resistance and tensile strength at intermediate temperatures. Both Mg/Si and Al/Cu precipitates are thermally unstable thus all three alloys have poor mechanical properties above 250 C due to the rapid coarsening of these precipitates.

Accordingly, there is a need to develop high temperature cast aluminum alloys for use in semi-permanent mold d casting articles, such as engine cylinder heads.

### SUMMARY

This disclosure provides cast aluminum alloys that have improved casting quality and high temperature properties for manufacturing articles made therefrom, such as engine cylinder heads made from sand casting, permanent mold, or semi-permanent mold casting.

The alloy may contain at least one of the castability and strength-enhancement elements, such as silicon, copper, magnesium, chromium, zirconium, vanadium, cobalt, strontium, sodium, barium, titanium, iron, manganese, and/or zinc. The microstructure of the alloy may contain at least one insoluble solidified and/or precipitated particles with at least one alloying element.

In one exemplary embodiment, which may be combined with or separate from the other examples and features provided herein, an aluminum alloy suitable for sand casting, permanent mold casting, or semi-permanent mold casting is provided. The aluminum alloy may contain: about 3.0 to about 12.0 weight percent silicon, about 0.5 to about 2.0 weight percent copper, about 0.2 to about 0.6 weight percent magnesium and about 0 to about 0.5 weight percent chromium; the aluminum alloy further includes about 0 to about 0.3 weight percent each of cobalt, vanadium, barium and/or zirconium; the aluminum alloy further includes 0 to about 0.3 weight percent of titanium, sodium, and strontium; the aluminum alloy further comprising 0 to about 0.5 weight percent of iron, manganese, and zinc; and the aluminum alloy further comprising about 0 to about 0.1 weight percent of other trace elements.

Additional features may be provided, including but not limited to the following: the aluminum alloy further comprising about 80 to about 91 weight percent aluminum; the aluminum alloy may contain: about 5.0 to about 9.0 weight percent silicon, about 0.6 to about 1.0 weight percent copper, about 0.4 to about 0.5 weight percent magnesium, about 0.25 to about 0.35 weight percent chromium; about 0.1 to about 0.2 weight percent each of zirconium, vanadium, and cobalt; about 0.0 to about 0.02 weight percent each of strontium and sodium; about 0 to about 0.2 weight percent titanium; about 0 to about 0.15 weight percent iron each of iron and manganese; about 0 to about 0.1 weight percent zinc; and about 0 to about 0.05 other trace elements.

In another example, which may be combined with or separate from the other examples and features provided herein, the aluminum alloy further comprising about 80 to about 91 weight percent aluminum; the aluminum alloy may contain: about 6.5 to about 7.5 weight percent silicon; about 0.7 to about 0.8 weight percent copper; about 0.35 to about 0.45 weight percent magnesium; about 0.3 to about 0.35 weight percent chromium; about 0.1 to about 0.15 weight percent each of zirconium, vanadium, and cobalt; about 0.005 to about 0.02 weight percent strontium; about 0.0 to about 0.05 weight percent each of nickel and boron; and 0.0 to about 0.2 weight percent titanium; about 0 to about 0.15 weight percent iron; about 0.0 to about 0.05 weight percent each of phosphorous, tin and calcium; about 0.0 to about 0.1 weight percent each of manganese and zinc; about 0 to about 0.05 weight percent of other trace elements.

Further additional features may be provided, such as: the iron and manganese content being provided each in an amount so that a sludge factor is less than or equal to 1.4, wherein the sludge factor is calculated by the following equation: Sludge factor=(1×wt % iron)+(2×wt % manganese)+(3×wt % chromium), and wherein the aluminum alloy may contain up to 0.5% chromium; the aluminum alloy containing essentially no Beta Iron Phase (β-Fe Phase); the aluminum alloy containing essentially about 1.0 to about 100 μm of silicon and iron rich intermetallic particles; the aluminum alloy containing essentially only Q phase (AlCuMgSi) nano-scale precipitates, wherein the aluminum alloy after heat treatment has a yield strength greater than or equal to 275 MPa, an ultimate tensile strength greater than or equal to 323 MPa, and an elongation of at least 2.3%; wherein the aluminum alloy at 300 C has a yield strength greater than or equal to 49 MPa, and an ultimate tensile strength greater than or equal to 56 MPa.

In yet another example, which may be combined with or separate from the other examples and features described herein, the aluminum allow may consist essentially of: about 5-8% weight percent silicon, about 0.15 weight percent each of iron, cobalt, vanadium, titanium, and zirconium; about 0.75 weight percent copper; about 0.1 weight percent manganese; about 0.4 weight percent magnesium; about 0.35 weight percent chromium; about 0.02 weight percent strontium; and the balance of aluminum and silicon.

In still another example, which may be combined with or separate from the other examples and features described herein, the aluminum alloy may consist essentially of: about 7.0 weight percent silicon; about 1% weight percent copper, about 0.4 weight percent magnesium; about 0.1 weight percent manganese; about 0.35 weight percent chromium; about 0.15 weight percent each of cobalt, zirconium, vanadium, titanium, and iron; about 0.02 weight percent strontium; and the balance aluminum and copper.

Further additional features may be provided, such as: the aluminum alloy containing as-cast particles essentially about 1.0 to about 100 μm each of silicon and iron rich intermetallic particles; the aluminum alloy containing solution treatment induced particles essentially about 100 nm to about 1 μm particles including aluminum-chromium-silicon, aluminum-zirconium, aluminum-vanadium, aluminum-titanium-silicon, and aluminum-titanium particles; and the aluminum alloy containing as-aged precipitates about 0.0 to about 100 nm each of Q-phase and S-phase.

A semi-permanent mold casting article, such as a cylinder head, is provided and cast from any of the versions of the aluminum alloy disclosed herein.

### BRIEF DESCRIPTION OF THE DRAWINGS

The drawings are provided for illustration purposes only and are not intended to limit this disclosure or the claims appended hereto.

FIG. 1 is a bottom view of a cylinder head casting in accordance with aspects of an exemplary embodiment;

FIG. 2 is a perspective view of a cylinder head casting in accordance with aspects of an exemplary embodiment;

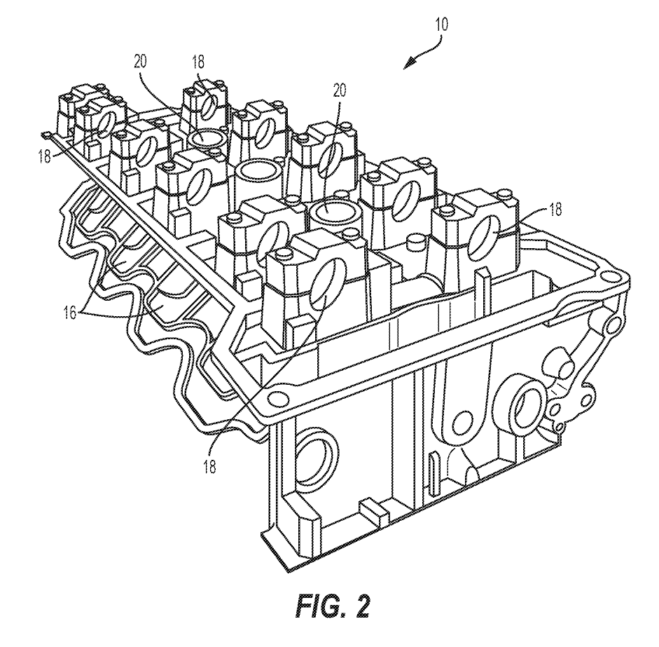

FIG. 3 is a graph showing a calculated phase diagram of an aluminum alloy showing phase transformations as a function of copper (Cu) content as according to aspects of an exemplary embodiment; and

FIG. 4 is a graph showing a calculated phase diagram of an aluminum alloy showing phase transformations as a function of silicon (Si) content in accordance with aspects of an exemplary embodiment.

### DETAILED DESCRIPTION

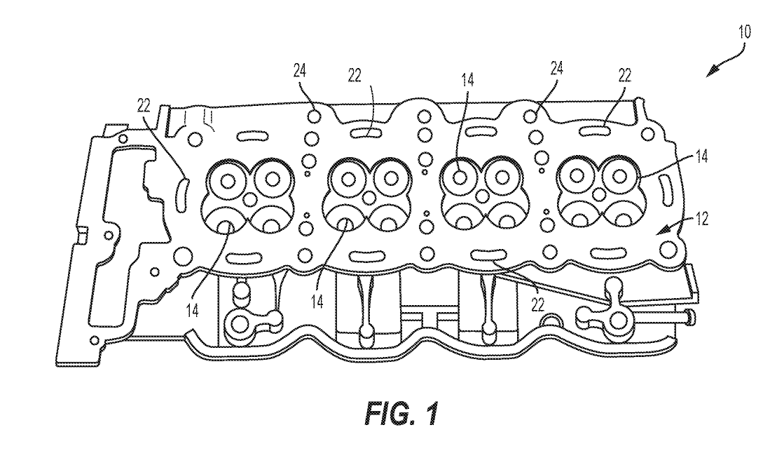

Cast aluminum alloys are provided having improved high temperature properties for cylinder heads. In FIGS. 1&2, an aluminum alloy cylinder head 10 produced using a semi-permanent mold casting method is illustrated in accordance with an exemplary embodiment and will now be described. In general, the cylinder head 10 includes features such as a head deck 12, combustion chambers 14, intake and exhaust ports 16, camshaft bearings 18, spark plug holes 20, water jacket openings 22, and oil passages 24, among other features. More particularly, the important features of the cylinder head 10 that are at least partially formed during the casting process include the head deck 12 and combustion chambers 14. Product specifications for the head deck 12 and combustion chambers 14 generally require higher yield and tensile strength than other areas of the cylinder head 10.

In comparison to other aluminum alloys, these alloys exhibit improved material strength and higher mechanical properties (see Table 1). These alloys may also exhibit improved castability and reduced porosity, as well as reduced hot cracking during tooling extraction. As a result, the scrap rate for aluminum casting and the manufacturing cost can be reduced. In some examples, alloy high temperature properties and engine performance can be improved. For example, the required inter-bore cooling can be reduced, eliminated, or avoided. Further, in some examples, the alloy density can be reduced. In some examples, the alloys may successfully undergo T6 or T7 treatments.

TABLE 1
Mechanical Properties of New Alloy

| | Current Alloy | New Alloy* |
|---|---|---|
| UTS @RT (MPa) | 313 | 323 |
| YS @RT (MPa) | 251 | 275 |
| Elongation @RT (%) | 6.2 | 2.3 |
| UTS @300 C. (MPa) | 41 | 56 |
| YS @300 C. (MPa) | 38 | 49 |
| Fatigue Strength @10\hat{ }7 cycles, | 64 | 76 |
| 150 C. (MPa) | | |
| Fatigue Strength @10\hat{ }7 cycles, | 49 | 53 |
| 200 C. (MPa) | | |

*Elevated temperature samples conditioned for 100 hours at temperature before testing. New alloy did not contain Cr or Co in first trial.

The alloy may contain at least one of the castability and strength enhancement elements such as silicon, copper, magnesium, manganese, iron, zinc, and nickel. The microstructure of the alloy contains one or more insoluble solidified and/or precipitated particles with at least one alloying element.

Two examples of composition ranges of the new alloy (called Version 1 and Version 2 in these examples) are listed in Table 2, compared with the other commercially available alloys for engine head castings.

TABLE 2
Chemical compositions of two versions of the new alloy and commercial
alloys A356, AS7GU (A356 + 0.5% Cu), 354, 319, 363 alloys.

| Alloy | Si | Sr | Ti | B | Mg | Fe | Mn | Cu | Zn | Ca/P/Sn/Ni | V/Zr/Co | Cr | other |
|---|---|---|---|---|---|---|---|---|---|---|---|---|---|
| A356 | 6.5-7.5 | | <0.2 | | 0.25-0.45 | <0.2 | <0.1 | <0.2 | <0.1 | <0.05 | | | <0.15 |
| AS7GU | 7.5-9.5 | | <0.2 | | 0.25-0.45 | <0.2 | <0.1 | 0.5 | <0.1 | <0.05 | | | <0.15 |
| 354 | 8.6-9.4 | | <0.2 | | 0.4-0.6 | <0.2 | <0.1 | 1.6-2.0 | <0.5 | <0.1 | | | <0.15 |
| 319 | 5.5-6.5 | | <0.25 | | <0.1 | <1.0 | <0.5 | 3.0-4.0 | <1.0 | <0.35 | | | <0.5 |
| 363 | 4.5-6.0 | | <0.2 | | 0.15-0.4 | <1.1 | <0.5 | 2.5-3.5 | 3-4.5 | <0.25 | | | <0.3 |
| V1 | 5.0-9.0 | 0.02 Max | 0.2 | | 0.4-0.5 | 0.15 Max | 0.15 Max | 0.6-1.0 | 0.1 Max | | 0.1-0.2 | 0.25-0.35 | 0.05 Max |
| (wt %) | | | Max | | | | | | | | | | |
| V2 | 6.5-7.5 | .005-0.02 | 0.20 | 0.05 | 0.35-0.45 | 0.15 Max | 0.10 Max | 0.7-0.8 | 0.10 Max | 0.05 Max | 0.1-0.15 | 0.30-0.35 | 0.05 Max |
| (wt %) | | | Max | Max | | | | | | | | | |

Tailored Cu content in the new aluminum alloys to form Q phase (AlSiMgCu) precipitates in comparison with traditional A356 & its variants.

Though copper is generally known to increase strength and hardness in aluminum alloys, on the downside, copper generally reduces the corrosion resistance of aluminum; and, in certain alloys and heat treatment conditions, copper increases stress corrosion susceptibility. Copper also increases the alloy freezing range and decreases feeding capability, leading to a high potential for shrinkage porosity. Furthermore, copper is expensive and heavy.

Artificial aging (T5) is used to produce precipitation hardening by heating the solution-treated and quenched castings to an intermediate temperature (e.g., 160-240 degrees C.), and then holding the castings for a period of time to achieve hardening or strengthening through precipitation. Considering that precipitation hardening is a kinetic process, the contents (supersaturation) of the retained solute elements in the as-quenched aluminum solid solution play an important role in the aging responses of the castings. Therefore, the availability and actual amount of hardening solutes in the aluminum soft matrix solution after casting and solution treatment has an effect on subsequent aging, which depends on the alloy composition, such as Cu and Mg content, and solution treatment temperature.

In Al—Si—Mg based cast aluminum alloy, like A356 alloy, the strengthening precipitates are mainly Mg2Si, which are coarsened very rapidly when temperature is above 200 C. Adding Cu in the alloy in this application is to suppress the formation of Mg2Si precipitates and form heat-resistant Q phase (AlCuMgSi). As the Q-phase has a composition range, Cu varies from 9 to 10 in atom percent, Mg varies from 35 to 45 atom percent, Si varies from 38 to 36 atom percent, and balance of aluminum. To merely form the Q-phase in the alloy, the key strengthening element Cu content in the bulk material varies from 0.5 to 2 weight percent, Mg content varies from 0.2 to 0.6 weight percent, and Si is above 0.7 weight percent.

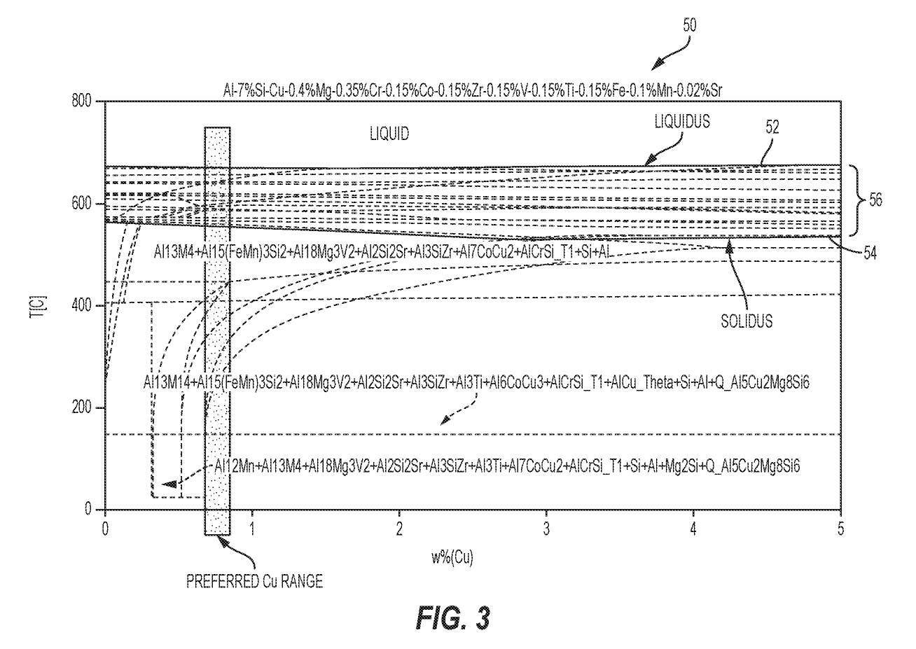

Excess Cu in the alloy however will form other low melting phases and thus reduce the formation of Q-phase. Typical sand cast aluminum alloys, such as 319, 354, or 363 contain 3-4% Cu in nominal composition and the Cu-containing phases consist of not only Q-phase but also θ-phase (Al2Cu), S-phase (AlSiMg), and AlMCu phases such as Al6CoCu3. Other Cu-containing low-melting phases can significantly affect alloy castability and increase porosity in the castings. One of the measures for castability of an alloy is freezing range between liquidus and solidus. The larger the freezing range, the higher the shrinkage porosity and lower castability. FIG. 3 illustrates a calculated phase diagram 50 of Al-7 wt % Si-0.4 wt % Mg based alloy with Cu content varying from 0 to 5 weight percent. The top line is called the liquidus boundary 52 and the bottom line is the solidus boundary 54. The temperature range between the liquidus boundary 52 and the solidus boundary 54 is the alloy freezing range 56. The freezing range 56 increases with Cu content in the alloy and reaches to a maximum value when Cu is about 3.5 weight percent. FIG. 1 also shows that no θ-phase (Al2Cu) will form if the Cu content in the bulk material is kept less than 1.0 weight percent.

To from Q-phase (AlCuMgSi), Mg is increased in the new aluminum alloys in comparison with traditional 319 & its variants.

To further improve the aging response of cast aluminum alloy, magnesium content in the new alloy should be kept no less than 0.2 wt %, and the preferred level is above 0.3 wt %. The maximum Mg content should be kept below 0.6 wt %, with a preferable level of 0.55 wt %, so that a majority of the Mg addition will stay in Al solid solution after solution treatment and form only Q-phase (AlCuMgSi) precipitates.

It was discovered that there was essentially no further improvement in strength when Mg was about 0.6 wt %.

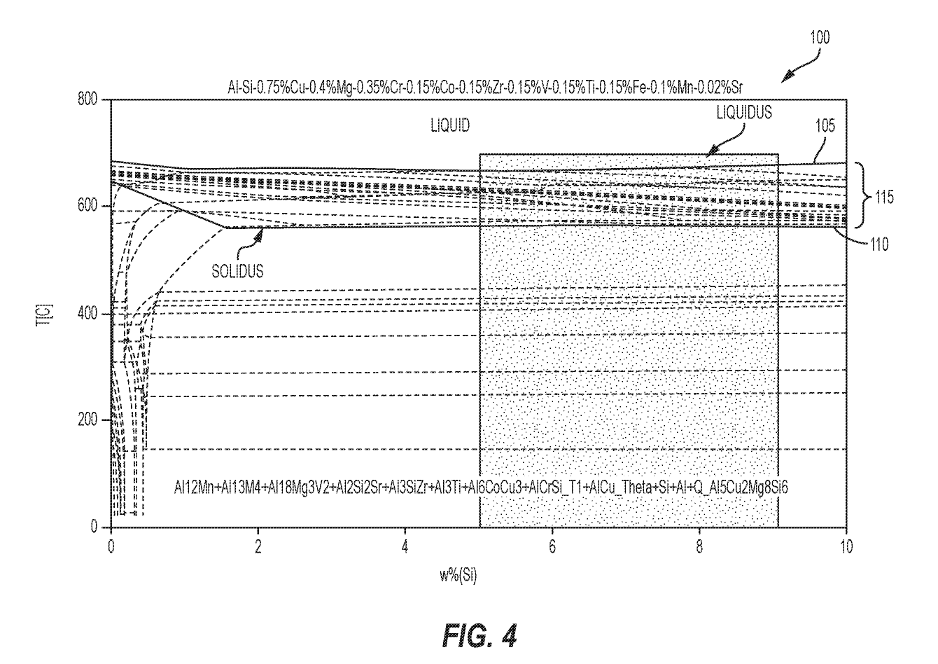

Si is an important element for cast aluminum alloy. Si increases alloy castability by increasing fluidity and releasing high latent heat during solidification to reduce shrinkage and improve feeding. High Si content also reduces alloy freezing range. For example, referring to FIG. 4 which illustrates a calculated phase diagram 100 of Al-0.75% Cu-0.4 wt % Mg based alloy with Si content varying from 0 to 10 weight percent. As with FIG. 3, the top line is called liquidus boundary 105 and the bottom line is the solidus boundary 110. The temperature range between the liquidus 105 and solidus 110 boundary lines is the alloy freezing range 115. The freezing range 115 is almost kept constant when the Si content is between 5.0 and 9.0 weight percent.

The alloys described herein may be used to manufacture a sand or permanent mold or semi-permanent mold cast article, such as engine cylinder heads. Therefore, it is within the contemplation of the inventors herein that the disclosure extend to cast articles, including cylinder heads, containing the improved alloy (including examples, versions, and variations thereof).

Furthermore, while the above examples are described individually, it will be understood by one of skill in the art having the benefit of this disclosure that amounts of elements described herein may be mixed and matched from the various examples within the scope of the appended claims.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. An aluminum alloy suitable for sand casting, permanent mold, or semi-permanent mold casting, the aluminum alloy comprising:
about 3 to about 12 weight percent silicon;
about 0.5 to about 2.0 weight percent copper;
about 0.2 to about 0.6 weight percent magnesium;
about 0.0 to about 0.5 weight percent chromium;
about 0.0 to about 0.3 weight percent each of zirconium, vanadium, cobalt, and barium;
about 0 to about 0.3 weight percent each of strontium, sodium, and titanium;
about 0 to about 0.5 weight percent each of iron manganese, and zinc; and
about 0.0.1 weight percent of other trace elements.

2. The aluminum alloy of claim 1, further comprising about 80 to about 91 weight percent aluminum.

3. The aluminum alloy of claim 2, further comprising as-cast particles essentially about 1.0 to about 100 μm each of silicon and iron rich intermetallic particles.

4. The aluminum alloy of claim 2, further comprising solution treatment particles essentially about 100 nm to about 1 μm particles including aluminum-chromium-silicon, aluminum-zirconium, aluminum-vanadium, and aluminum-titanium particles.

5. The aluminum alloy of claim 2, further comprising as-aged precipitates about 0.0 to about 100 nm each of Q-phase and S-phase.

6. An aluminum alloy suitable for sand casting, permanent mold, or semi-permanent mold casting, the aluminum alloy comprising:
about 5 to about 9 weight percent silicon;
about 0.6 to about 1.0 weight percent copper;
about 0.4 to about 0.5 weight percent magnesium;
about 0.25 to about 0.35 weight percent chromium;
about 0.1 to about 0.2 weight percent each of zirconium, vanadium, and cobalt;
about 0 to about 0.02 weight percent each of strontium and sodium;
about 0 to about 0.2 weight percent titanium;
about 0 to about 0.15 weight percent iron
about 0 to about 0.15 weight percent manganese;
about 0 to about 0.1 weight percent zinc; and
about 0 to about 0.05 weight percent of other trace elements.

7. The aluminum alloy of claim 6, further comprising about 80 to about 91 weight percent aluminum.

8. The aluminum alloy of claim 7 further comprising as-cast particles essentially about 1.0 to about 100 μm each of silicon and iron rich intermetallic particles.

9. The aluminum alloy of claim 8 further comprising solution treatment particles essentially about 100 nm to about 1 μm particles including aluminum-chromium-silicon, aluminum-zirconium, aluminum-vanadium, aluminum-titanium-silicon, and aluminum-titanium particles.

10. The aluminum alloy of claim 9 further comprising as-aged precipitates about 0.0 to about 100 nm each of Q-phase and S-phase.

11. An aluminum alloy suitable for sand casting, permanent mold, or semi-permanent mold casting, the aluminum alloy comprising:
about 6.5 to about 7.5 weight percent silicon;
about 0.7 to about 0.8 weight percent copper;
about 0.35 to about 0.45 weight percent magnesium;
about 0.3 to about 0.35 weight percent chromium;
about 0.1 to about 0.15 weight percent each of zirconium, vanadium, and cobalt;
about 0.005 to about 0.02 weight percent strontium;
about 0 to about 0.2 weight percent titanium;
about 0 to about 0.05 weight percent each of barium, calcium, tin, nickel, and phosphorous;
about 0 to about 0.15 weight percent iron;
about 0 to about 0.10 weight percent manganese;
about 0 to about 0.10 weight percent zinc; and
about 0 to about 0.05 weight percent of other trace elements.

12. The aluminum alloy of claim 11 further comprising about 0 to about 1.4 sludge factor.

13. The aluminum alloy of claim 11 further comprising about 80 to about 91 weight percent aluminum.

14. The aluminum alloy of claim 13 further comprising as-cast particles essentially about 1.0 to about 100 μm each of silicon and iron rich intermetallic particles.

15. The aluminum alloy of claim 14 further comprising solution treatment particles essentially about 100 nm to about 1 μm particles including aluminum-chromium-silicon, aluminum-zirconium, aluminum-vanadium, aluminum-titanium-silicon, and aluminum-titanium particles.

16. The aluminum alloy of claim 15 further comprising as-aged precipitates about 0.0 to about 100 nm each of Q-phase and S-phase.

17. An aluminum alloy suitable for sand casting, permanent mold, or semi-permanent mold casting, the aluminum alloy consisting of:
about 7.0 weight percent silicon;
about 1.0 weight percent copper;
about 0.4 weight percent magnesium;
about 0.35 weight percent chromium;
about 0.15 weight percent each of zirconium, vanadium, titanium, iron and cobalt;
about 0.02 weight percent strontium; and
remaining balance aluminum and copper.

18. The aluminum alloy according to claim 5 in the form of sand casting, permanent mold, or semi-permanent mold cast article.

19. The aluminum alloy according to claim 10 in the form of a sand casting, permanent mold, or semi-permanent mold cast article.

20. The aluminum alloy according to claim 16 in the form of a sand casting, permanent mold, or semi-permanent mold cast article.
